(19) United States
(12) Patent Application Publication
(10) Pub. No.: US 2023/0395826 A1
(43) Pub. Date: Dec. 7, 2023

(54) STACK TERMINATING PLATE HAVING A SUPPORT ELEMENT

(71) Applicant: Reinz-Dichtungs-GmbH, Neu-Ulm (DE)

(72) Inventors: André SPEIDEL, Bussmannshausen (DE); Rainer GLUECK, Tomerdingen (DE)

(21) Appl. No.: 18/327,804

(22) Filed: Jun. 1, 2023

(30) Foreign Application Priority Data
Jun. 2, 2022 (DE) 20 2022 103 135.5

(51) Int. Cl. H01M 8/0276; H01M 8/0258

(52) U.S. Cl. CPC H01M 8/0276; H01M 8/0258

(57) ABSTRACT

An assembly for an electrochemical system comprising a separator plate and a support element is disclosed. The separator plate is designed as a single layer and as a stack terminating plate. The electrochemical system may be a fuel cell system, an electrochemical compressor, an electrolyzer, a humidifier for an electrochemical system, or a redox flow battery.

### CROSS-REFERENCE TO RELATED APPLICATION

The present application claims priority to German Utility Model Application No. 20 2022 103 135.5, entitled “STACK TERMINATING PLATE HAVING A SUPPORT ELEMENT”, and filed on Jun. 2, 2022. The entire contents of the above-listed application is hereby incorporated by reference for all purposes.

### TECHNICAL FIELD

The present disclosure relates to an assembly for an electrochemical system, comprising a separator plate, which is designed as a single layer and as a stack terminating plate, and a support element. The electrochemical system may be a fuel cell system, an electrochemical compressor, an electrolyzer, a humidifier for an electrochemical system, or a redox flow battery.

### BACKGROUND & SUMMARY

Known electrochemical systems of the aforementioned type usually comprise a stack of electrochemical cells, which are each separated from one another by separator plates, for example bipolar or monopolar plates. Such separator plates may serve, for example, for indirectly electrically contacting the electrodes of the individual electrochemical cells (for example fuel cells) and/or for electrically connecting adjacent cells (series connection of the cells). The separator plates are often formed of two individual layers which are joined together. The individual layers of a separator plate may be joined together in a materially bonded manner, for example by one or more welded joints, such as by one or more laser-welded joints. The term bipolar or monopolar plate results from the arrangement of the respective separator plate, which comprises two individual layers, relative to the media. In the case of bipolar plates, different media flow on two surfaces, whereas in the case of monopolar plates the same media flow on the two surfaces. When mention is made below of bipolar plates or of a bipolar plate, this may also mean monopolar plates or a monopolar plate, unless otherwise stated.

The separator plates may have or form structures which are designed, for example, to supply one or more media to the electrochemical cells bounded by adjacent separator plates and/or to convey reaction products away therefrom. The media may be fuels (for example hydrogen or methanol), reaction gases (for example air or oxygen), or reaction products (for example water). Furthermore, the separator plates may have structures for guiding a cooling medium through the bipolar plates formed of two individual layers, such as through a cavity enclosed by the individual layers. The separator plates may also be designed to dissipate the waste heat that is generated when converting electrical or chemical energy in the electrochemical cell, and to seal off the various media channels and/or cooling channels with respect to each other and/or with respect to the outside.

Furthermore, the separator plates usually each have a plurality of through-openings. Through the through-openings, the media and/or the reaction products can be fed to the electrochemical cells bounded by adjacent separator plates of the stack, or into the cavity formed by the individual layers of the separator plate, or can be discharged from the cells or from the cavity.

The electrochemical cells also usually comprise one or more membrane electrode assemblies (MEAs). The MEAs may have one or more gas diffusion layers, which are usually oriented towards the separator plates and are formed, for example, as a metal or carbon fleece. In addition, the MEAs each have a frame-like reinforcing layer, which surrounds the electrochemically active region of the MEA and is typically made of an electrically insulating material.

The stack comprising the separator plates and the electrochemical cells is usually terminated by an end plate at each end of the stack. An outer plate, if present, can be arranged on the surface of the end plate facing away from the plate stack. If an outer plate is used, usually the end plate serves primarily to insulate and the outer plate serves primarily to absorb forces. At least one of the end plates typically has one or more media ports. Lines for supplying the media and the coolant and/or for discharging the reaction products and the coolant can be connected to these ports. In addition, at least one of the end plates or a contact plate arranged directly adjacent to the end plate on the side thereof facing towards the stack usually has electrical connectors, via which the cell stack can be electrically connected to a load in the case of a fuel cell or to a voltage source in the case of an electrolyzer. The respective other end plate in any case serves for compressing and/or sealing the stack. The respective other end plate may or may not comprise media ports. The separator plate of the stack that is located closest or adjacent to an end plate is also called the stack terminating plate.

Typically, a sealing device is arranged between the stack terminating plate and the end plate. Said sealing device serves to seal off the system with respect to the outside and/or to seal off different lines or sections of the electrochemical system with respect to each other. In known systems, the sealing between the stack terminating plate and the end plate is effected, for example, by metal beads coated by screen printing. However, this screen print tends to stick to the mechanically machined, at least slightly rough plastic surfaces of the end plate. In addition, the sealing device may become detached or damaged when the stack terminating plate and the end plate, which are usually made of different materials and therefore have different thermal expansion coefficients, are displaced relative to each other, such as in the lateral direction, e.g. orthogonal to the stacking direction, in the event of the temperature changes. Usually the separator plates and thus also the stacking terminating plate are made of metal, for example of stainless steel or a titanium alloy, whereas the end plate is made of plastic or largely of plastic.

In some applications, the sealing device has to perform its function equally reliably in a temperature range between a minimum temperature of, for example, −40° C. and a maximum temperature of, for example, +100° C. Such temperature changes may occur during the start of operation of a fuel cell system at ambient temperature or during a cold start in winter at sub-zero temperatures up to the maximum operating temperature of the stack. The effects of the detachment and sticking of the coating may become evident when the stack is disassembled, with the coating being pulled away from the stack terminating plate as a result of the detachment that has previously taken place.

To prevent or at least reduce this relative displacement in the event of temperature changes, the end plate could also be made of metal. However, this increases both the manufacturing costs and the weight of the system, which is undesirable for many applications. On the other hand, the sealing of the interface between the end plate and the stack terminating plate by means of a rubber seal (O-ring or floppy gasket), which is partially inset into at least one of the plates or is arranged thereon, may lead to difficulties in adjusting the height and force of the sealing system due to the considerable subsidence of such seals.

This problem is also known from the publication DE 20 2014 002 512 U1. Said document proposed a sealing device between one of the two end plates and the terminating bipolar plate, which sealing device is designed in such a way that, in the event of temperature changes, the sealing function is effected only or at least also by a sliding of the end plate and/or of the stack terminating plate along the sealing device. However, this requires additional surface machining and/or a special coating.

In the publication DE 20 2014 007 977 U1, use is made not of a terminating bipolar plate but rather of a separator plate designed as a single layer and as a stack terminating plate, which is adjacent to a contacting plate arranged between the end plate and the stack terminating plate. A plurality of stacked, double-layer separator plates are also present. Sealing beads are provided in order to seal off the through-openings formed in the terminating plate and through-openings formed in the separator plates. In the two-layer separator plates, the sealing beads are arranged congruently on both sides of the separator plates and point with their bead tops away from each other. When looking at the sealing beads in terms of their spring behavior, the congruent sealing beads of a double-layer separator plate are connected in series. One disadvantage of this design is that the sealing beads of the single-layer terminating plate have a different spring behavior or a different spring characteristic than the series-connected sealing beads of the double-layer separator plates. The differing spring behavior may have an effect on the sealing behavior and may lead to local leaks.

In order to adjust the differing spring behavior of the stack terminating plate, the latter can be modified by means of suitable structures or embossments. However, this has the disadvantage that the spring behavior of the sealing bead has to be configured separately and the stack terminating plate differs from the other separator plates or bipolar plates, which usually leads to higher manufacturing costs and requires separate tools.

The object of the present disclosure is to at least partially solve the disadvantages of the conventional systems. For instance, it would be desirable to provide a plate assembly and an electrochemical system that have good leaktightness. For example, the assembly and the electrochemical system can also be able to be manufactured as easily and as cost-effectively as possible.

This object is achieved by the plate assembly and the electrochemical system according to the independent claims. Specific embodiments are disclosed in the dependent claims and in the following description.

Accordingly, an assembly for an electrochemical system is proposed. The assembly comprises a first separator plate, which is designed as a single layer and as a stack terminating plate, and a support element, wherein the first separator plate has a first sealing bead for sealing off an area of the first separator plate, wherein the first sealing bead projects out of a plate plane defined by the first separator plate and has a bead interior, which is open on a rear side of the first separator plate, and a bead top, which is cantilevered on a front side of the first separator plate, wherein the support element projects into the bead interior in order to support the bead top. As a result, the bead can usually no longer be deformed beyond its operating point.

By virtue of the assembly described, an embodiment of the first sealing bead of the first separator plate within the spring set of stacked sealing beads of stacked separator plates can be bypassed, e.g. effectively switched off, so that only sealing beads of comparable spring behavior are connected in series. As a result, the sealing behavior of the assembly as a whole can be improved. In addition, the spring behavior of the first sealing bead does not have to be configured separately.

In one embodiment, the support element is designed as a rigid spacer. The support element may therefore be substantially incompressible, for instance in the compressed state of the assembly or in the installed state of the assembly in an electrochemical system, and may have a very high, almost infinitely large spring constant compared to the sealing bead, as a result of which the spring behavior of the combination comprising support element and sealing bead is defined substantially only by the vanishingly small spring behavior of the support element compared to the spring behavior of the other sealing beads of the stack.

In this specification and hereinbelow, a height direction is defined perpendicular to the plate plane. A maximum height of the support element is often smaller than a height of the first sealing bead measured from the plate plane to the bead top in the non-compressed state of the assembly, such as to the neutral axis of the bead top in the non-compressed state of the assembly. As a result, the first sealing bead can be compressed to a certain extent, namely until the first sealing bead butts against the support element, which corresponds to its operating point, and then experiences a hard mechanical stop due to the high rigidity of the support element. Either a height measurement from neutral axis to neutral axis, e.g. without the material thickness, or a height measurement from a lower surface of the non-deformed first separator plate to an upper surface of the bead top may be meant here. However, it may be helpful to consider only the clear height of the bead interior, e.g. the gap between the surface of the end plate and the inner surface of the bead facing towards it. The height of the support element may be at least 60%, at least 70%, at least 75%, or at least 80% of the bead height in the non-compressed state of the assembly.

The first separator plate may have at least one through-opening for the passage of a fluid, wherein the first sealing bead is arranged around the through-opening and seals off the latter. The sealing bead may often be designed as a full bead. For example, a bead flank is formed on both sides of the bead top. In this case, it is possible for the bead flanks on the two sides to be either symmetrical or asymmetrical in relation to each other. By way of example, it is possible that a first bead flank descends in a single stage, while the other bead flank overcomes the same height as the first bead flank overall, but has over this height a plurality of steps or sections, between which the plate material extends substantially parallel to the plate plane.

The support element and/or the first sealing bead may have at least one fluid passage for the passage of a fluid, such that the fluid that passes through the through-opening. The fluid passage may enable or ensure that the fluid can be routed from the rear side to the front side or from the front side to the rear side of the first separator plate. A double change of sides, e.g. a change of sides in each bead flank, is also possible. If the fluid is a coolant, for example, the first separator plate may be cooled on its rear side facing towards the end plate. If the fluid is a reaction medium, the first separator plate may be provided with reaction medium on its front side facing towards the stack.

It may be provided that the support element extends along the entire course of the first sealing bead. This enables a high degree of stiffness of the combination of sealing bead and support element, said stiffness being as homogeneous as possible along the course of the sealing bead. The support element may have an intrinsically closed course and may, for example, be ring-shaped. Alternatively, the course of the support element may have an interruption or an incomplete ring closure, as a result of which the support element has two free ends, which nevertheless butt against each other or are arranged against or next to each other. In this case, the support element may be made from a wire or other continuous material, for example, which brings advantages in terms of manufacture. The interruption or the free ends of the support element may make it easier to install the support element. As an alternative or in addition, the interruption in the course of the support element may also form or contribute to the aforementioned fluid passage.

The support element may have, for example, a round, oval or rounded-rectangular cross-section. With the exception of the fluid passage mentioned above, the support element may be designed as a solid body. Alternatively, the support element may have a central cutout and may accordingly have a ring-shaped cross-section; it could also comprise a coiled thin sheet material or a coiled wire material, in which case both the coil and the base materials can have as little rebound as possible.

A plate body of the first separator plate and/or the support element are often made of a metal material.

It may be provided that the first separator plate, for example the first sealing bead, has a coating, such as in the region of its bead top. The coating is applied to the plate body and may for example be designed as a polymer coating, wherein the coating differs from the plate body of the first separator plate in terms of the material. The coating of the first sealing bead may act as a microseal and may be located opposite the support element on different sides of the separator plate.

The assembly may further comprise a contacting plate adjacent to the rear side of the first separator plate, e.g. on the side of the first separator plate facing towards the end plate, wherein the separator plate and the contacting plate are connected to each other electrically and/or in a media-tight manner. The support element and the contacting plate may, for example, be formed in one piece. Alternatively, the support element and the contacting plate may be formed as two individual parts. In this case, the support element may be arranged between the contacting plate and the first separator plate. The contacting plate may have a fastening possibility for fastening the contacting plate to an end plate. In some embodiments, the support element may be inset, partially, into a depression provided in the contacting plate and/or in the end plate.

A plate body of the contacting plate may be made of a metal material. The contacting plate may have a thickness of at least 0.5 mm, at least 1.0 mm, at least 2.0 mm and/or at most 10 mm, at most 8 mm, and at most 5 mm. Overall, in electrolyzer applications, the thickness of the contacting plate may be at least two times, at least five times or ten times greater than a thickness of the first separator plate. In fuel cell applications, the thickness of the contacting plate may be at least forty times, for example at least fifty times the thickness of the separator plate. The thickness of the respective component may in this case be measured in the aforementioned height direction.

It may be provided that the first sealing bead and/or the support element in each case have at least one fluid passage which is designed to route a fluid into an intermediate space arranged or formed between the first separator plate and the contacting plate. The fluid passage has already been mentioned above and, if the fluid is designed as a coolant for example, may provide for cooling the rear side of the first separator plate.

In one embodiment, the first separator plate and the contacting plate are welded to each other, for example in order to seal off an area arranged between the separator plate and the contacting plate. The weld may be designed, for example, as a sealing line. The sealing mentioned here therefore does not mean a hermetic sealing, but rather the formation of a sealing line. Elsewhere, the area in question may be supplied with a fluid via the fluid passages.

The assembly may further comprise a first end plate, wherein the sealing bead of the first separator plate, such as the bead top thereof, points away from the end plate and the support element is arranged between the separator plate and the end plate. The first end plate often has a plurality of media ports, wherein the media ports of the first end plate are fluidically connected to through-openings of the first separator plate. A plate body of the first end plate may be at least partially or predominantly made of a polymer material. The contacting plate is usually adjacent to the first end plate and is thus arranged between the first end plate and the first separator plate.

The assembly may additionally comprise an outer plate, which is arranged on a surface of the first end plate facing away from the first separator plate. The first end plate usually serves primarily to electrically insulate the assembly, while the outer plate is intended to absorb forces in a compressed state of the assembly.

The assembly may further comprise a second separator plate, which is designed as a double layer and comprises a first layer and a second layer which are connected to each other. The first layer and the second layer are usually designed as individual layers. Wherein the second separator plate may be designed to be identical to the separator plate which is a single layer and a stack terminating plate. Here, identical is intended to mean that the plates are to be regarded as being structurally the same and may be identical in construction. Using plates of identical construction results in significant simplifications and savings in the manufacture and design of the plates. The second separator plate is typically arranged on the front side of the first separator plate; it is therefore the single layer of the rest of the stack that is closest to the first separator plate. The first separator plate and the second separator plate are usually not in direct contact. Instead, a membrane electrode assembly (MEA) is usually arranged between the first separator plate and the second separator plate. Furthermore, at least one gas diffusion layer may be arranged between the two separator plates. A gas diffusion layer is typically arranged on each flat side of the MEA. A plate body of the second separator plate (or a plate body of the first layer and a plate body of the second layer) may be made of a metal material.

The second layer of the second separator plate may have a second sealing bead for sealing off an area of the second separator plate, wherein the first sealing bead of the first separator plate and the second sealing bead of the second layer face each other with their bead tops and extend with their bead tops parallel to each other. In plan view, the two beads, or at least the two bead tops, run in alignment. However, the two sealing beads are usually not in direct contact. As already indicated above, usually a portion of the MEA, such as an electrically insulating reinforcing layer of the MEA, is arranged between the two sealing beads. The first sealing bead and the second sealing bead may be regarded as spring elements connected in series. While the first sealing bead is stiffened by means of the support element in such a way that it constitutes a quasi-rigid element above its operating point, the second sealing bead has a considerable elasticity in comparison thereto. In one embodiment, the first sealing bead and the second sealing bead are identical in construction.

The first sealing bead and/or the second sealing bead are typically integrally formed in the respective separator plate, more precisely in the plate body of the respective separator plate, for example by embossing, hydroforming and/or deep-drawing.

The present disclosure additionally proposes an electrochemical system. The electrochemical system comprises the assembly described above, a plurality of further separator plates, and a second end plate. The first end plate has a plurality of media ports, wherein the media ports of the first end plate are fluidically connected to through-openings of the first separator plate, wherein the first separator plate and the further separator plates are arranged and compressed between the two end plates, as a result of which a stack is formed.

The second end plate may serve for compressing and/or sealing the stack. The second end plate may or may not have media ports.

In addition, at least one of the two end plates usually has electrical connectors, via which the system can be electrically connected to a load or, such as in the case of an electrolyzer, to a voltage source. Alternatively, it is also possible to provide the electrical connectors not in an end plate, but rather in the aforementioned contacting plate.

The electrochemical system may additionally also have, in its end region facing towards the second end plate, an assembly comprising a single-layer separator plate in which, as described above, a sealing bead is formed, in the interior of which a support element is accommodated. However, it is not mandatory that a through-opening is arranged also in this single-layer separator plate. Instead, it may be advantageous if no fluid through-opening is provided. In some cases, however, it is advantageous if at least one vent opening is formed in the relevant area of this separator plate. Comparable solutions are disclosed, for example, in DE 20 2020 105 396 U1.

Exemplary embodiments of the separator plate and of the electrochemical system are shown in the figures and will be explained in greater detail by means of the following description.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows, in a perspective view, two bipolar plates of the system according to FIG. 1 with a membrane electrode assembly (MEA) arranged between the bipolar plates.

FIG. 3 schematically shows a section through part of a plate stack in the region of an end plate according to the prior art.

FIG. 4 schematically shows a section through part of a plate stack in the region of an end plate according to one embodiment.

FIG. 5 schematically shows a section through part of a plate stack in the region of an end plate according to a further embodiment.

FIGS. 6A-6C schematically show a section through part of a plate stack in the region of an end plate according to a further embodiment, as well as a plan view and a sectional view of a portion of a separator plate in the compressed state.

FIG. 7 schematically shows a section through part of a plate stack in the region of an end plate according to a further embodiment.

FIG. 8 schematically shows a section through part of a plate stack in the region of an end plate according to a further embodiment.

FIG. 9 schematically shows a cut-away oblique view through part of a plate stack in the region of an end plate according to a further embodiment.

FIGS. 10A-10C schematically show plan views of different support elements.

FIGS. 11A-11D schematically show cross-sections and an oblique view of different support elements.

### DETAILED DESCRIPTION

In the following description and in the figures, recurring and functionally identical features are provided with the same reference signs. For reasons of clarity, reference signs are in some cases not indicated in every example, even though the associated elements may be present in the example in question.

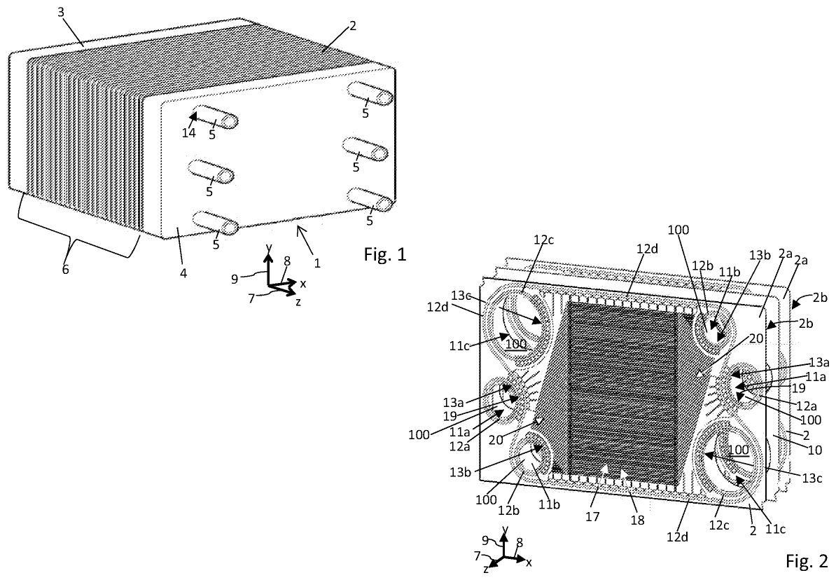

FIG. 1 shows an electrochemical system 1 comprising a plurality of metal separator plates 2 of identical construction, which are arranged in a stack 6 and are stacked along a z-direction 7. The separator plates 2 of the stack 6 are usually clamped between two end plates 3, 4. The z-direction 7 is also referred to as the stacking direction. In the present example, the system 1 is a fuel cell stack. Each two adjacent separator plates 2 of the stack thus bound an electrochemical cell, which serves for example to convert chemical energy into electrical energy.

In alternative embodiments, the system 1 may also be designed as an electrolyzer, as a compressor, as a humidifier for an electrochemical system, or as a redox flow battery. In these electrochemical systems, use can likewise be made of separator plates, such as monopolar plates or bipolar plates constructed from two individual layers. The structure of these separator plates may then correspond to the structure of the separator plates 2 explained in detail here, although the media guided on and/or through the separator plates in the case of an electrolyzer, an electrochemical compressor or a redox flow battery may differ in each case from the media used for a fuel cell system.

To form the electrochemical cells of the system 1, a membrane electrode assembly (MEA) 10 is arranged in each case between adjacent separator plates 2 of the stack (see, for example, FIG. 2). Each MEA 10 typically contains at least one membrane, for example an electrolyte membrane. Furthermore, a gas diffusion layer 16 (GDL) may be arranged on one or both surfaces of the MEA. The MEA 10 often additionally comprises a frame-like reinforcing layer 15, which frames the electrolyte membrane and reinforces it. The reinforcing layer 15 is usually electrically insulating and prevents a short-circuit from occurring during operation of the electrochemical system 1.

In alternative embodiments, the system 1 may also be designed as an electrolyzer, as an electrochemical compressor, as a redox flow battery, or as a humidifier for an electrochemical system. Separator plates can likewise be used in these electrochemical systems. The structure of these separator plates may then correspond to the structure of the separator plates 2 explained in detail here, although the media guided on and/or through the separator plates in the case of an electrolyzer, an electrochemical compressor, a redox flow battery or a humidifier may differ in each case from the media used for a fuel cell system.

The z-axis 7, together with an x-axis 8 and a y-axis 9, spans a right-handed Cartesian coordinate system. The separator plates 2 each define a plate plane, each of the plate planes of the separator plates being oriented parallel to the x-y plane and thus perpendicular to the stacking direction or to the z-axis 7. The first end plate 4 usually has a plurality of media openings 14 with connected media ports 5, via which media can be supplied to the system 1 and via which media can be discharged from the system 1. Said media that can be supplied to the system 1 and discharged from the system 1 may comprise, for example, fuels such as molecular hydrogen or methanol, reaction gases such as air or oxygen, reaction products such as water vapor or depleted fuels, or coolants such as water and/or glycol. In an embodiment of a humidifier, temperature control is usually dispensed with, so that then there are only four media ports instead of the six media ports 5 shown in FIG. 1. Similarly, in an embodiment of electrolyzers, only four media ports 5 may be present if the electrolyzers are cooled by the reaction media.

Not shown in FIG. 1 are electrical connectors which are likewise arranged on the end plate 4 and via which an electrical load can be connected to the fuel cell stack 6.

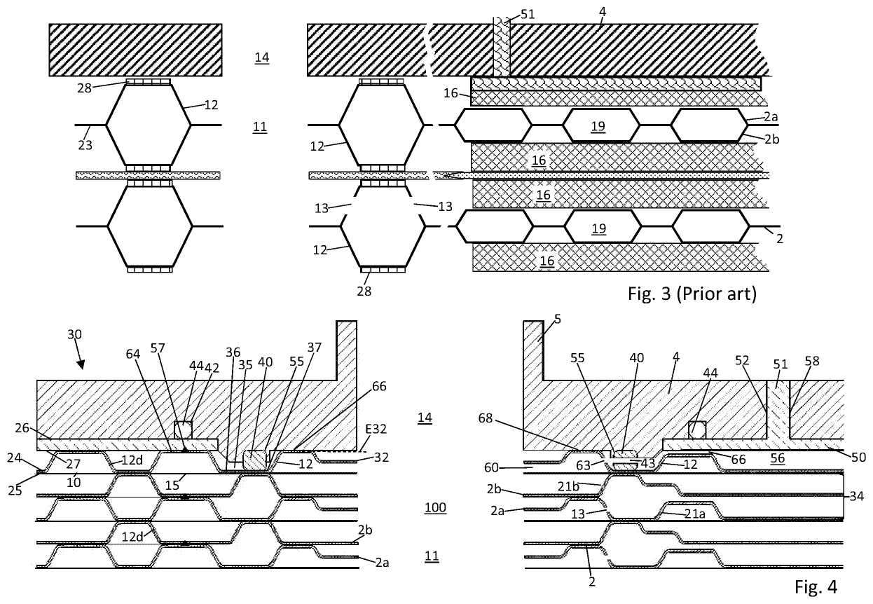

Both known separator plates, as shown in FIGS. 2 and 3, and separator plates according to the present disclosure, as shown from FIG. 4 onwards, can be used in an electrochemical system as shown in FIG. 1.

FIG. 2 shows, in a perspective view, two adjacent separator plates 2, known from the prior art, of an electrochemical system of the same type as the system 1 from FIG. 1, as well as a membrane electrode assembly (MEA) 10 which is arranged between these adjacent separator plates 2 and is likewise known from the prior art, the MEA 10 in FIG. 2 being largely obscured by the separator plate 2 facing towards the viewer. An embodiment of the separator plate 2 is formed of two individual layers 2a, 2b which are joined together in a materially bonded manner (see also, for example, FIGS. 4 to 8), of which only the first individual layer 2a facing towards the viewer is visible in FIG. 2, said first individual layer obscuring the second individual layer 2b. The individual layers 2a, 2b may each be manufactured from a metal sheet, for example from a stainless steel sheet. The individual layers 2a, 2b may for example be welded to each other along their outer edge, for example by laser-welded joints.

The individual layers 2a, 2b typically have through-openings, which are aligned with one another and form through-openings 11a-c of the separator plate 2. When a plurality of separator plates of the same type as the separator plate 2 are stacked, the through-openings 11a-c form lines 100 which extend through the stack 6 in the stacking direction 7 (see FIG. 1 and FIGS. 3-7). Typically, each of the lines 100 formed by the through-openings 11a-c is fluidically connected to one of the media ports 5 in the end plate 4 of the system 1. For example, coolant can be introduced into the stack 6 via the lines 100 formed by the through-openings 11a, while the coolant can be discharged from the stack via other through-openings 11a. In contrast, the lines 100 formed by the through-openings 11b, 11c may be designed to supply fuel and reaction gas to the electrochemical cells of the fuel cell stack 6 of the system 1 and to discharge the reaction products from the stack. The media-guiding through-openings 11a-c are substantially parallel to the plate plane.

In order to seal off the through-openings 11a-c with respect to the interior of the stack 6 and with respect to the surrounding environment, the first individual layers 2a may each have sealing arrangements in the form of sealing beads 12a-c, which are arranged in each case around the through-openings 11a-c and in each case completely surround the through-openings 11a-c. On the rear side of the separator plates 2, facing away from the viewer of FIG. 2, the second individual layers 2b have corresponding sealing beads for sealing off the through-openings 11a-c (not shown). A bead arrangement 12 of the separator plate 2 can be understood as a combination of two sealing beads 12a of the individual plates 2a, 2b, sealing beads 12b of the individual plates 2a, 2b or sealing beads 12c of the individual plates 2a, 2b, which sealing beads cooperate, point away from each other and are located on opposite sides of the separator plate 2.

In an electrochemically active region 18, the first individual layers 2a have, on the front side thereof facing towards the viewer of FIG. 2, a flow field 17 with first structures for guiding a reaction medium along the outer side (or also front side) of the individual layer 2a. In FIG. 2, these first structures are defined by a plurality of webs and by channels extending between the webs and delimited by the webs. On the front side of the separator plates 2, facing towards the viewer of FIG. 2, the first individual layers 2a additionally each have a distribution and/or collection region 20. The distribution and/or collection region 20 comprises structures which are designed to distribute over the active region 18 a medium that is introduced from a first of the two through-openings 11b into the adjoining distribution region 20 and to collect or to pool, via the collection region 20, a medium flowing towards the second of the through-openings 11b from the active region 18. In FIG. 2, the distributing structures of the distribution and/or collection region 20 are likewise defined by webs and by channels extending between the webs and delimited by the webs.

The sealing beads 12a-12c are crossed by passages 13a-13c which are integrally formed in the individual layers 2a, 2b, the passages usually comprising apertures in and/or elevations of the plate material. Both on the underside of the upper individual layer 2a and on the upper side of the lower individual layer 2b, the passages 13a form a connection between the through-opening 11a and the distribution region 20, while the passages 13b in the upper individual layer 2a and the passages 13c in the lower individual layer 2b establish a corresponding connection between the through-opening 11b or 11c and the respectively adjoining distribution region 20. By way of example, the passages 13a enable coolant to pass between the through-opening 12a and the distribution and/or collection region 20, so that the coolant enters the distribution and/or collection region 20 between the individual layers 2a, 2b and is guided out therefrom.

Furthermore, the passages 13b enable hydrogen to pass between the through-opening 12b and the distribution or collection region on the upper side of the upper individual layer 2a; these passages 13b adjoin apertures which face towards the distribution or collection region and which extend at an angle to the plate plane. Hydrogen, for example, thus flows through the passages 13b from the through-opening 12b to the distribution or collection region 20 on the upper side of the upper individual layer 2a, or in the opposite direction. The passages 13c enable air, for example, to pass between the through-opening 12c and the distribution or collection region 20, so that air enters the distribution or collection region on the underside of the lower individual layer 2b and is guided out therefrom.

The first individual layers 2a each also have a further sealing arrangement in the form of a perimeter bead 12d, which extends around the flow field 17 of the active region 18 and also around the distribution and/or collection region 20 and the through-openings 11b, 11c and seals these off with respect to the through-openings 11a, that is to say with respect to the coolant circuit, and with respect to the environment surrounding the system 1. The second individual layers 2b each comprise corresponding perimeter beads 12d. The structures of the active region 18, the distributing or collecting structures of the distribution and/or collection region 20 and the sealing beads 12a-d are each formed in one piece with the individual layers 2a and are integrally formed in the individual layers 2a, for example in an embossing (vertical or roller embossing), hydroforming or deep-drawing process. The same applies to the corresponding flow fields, distributing structures and sealing beads of the second individual layers 2b. Each sealing bead 12a-12d may have in cross-section at least one bead top and two bead flanks, but a substantially angular arrangement between these elements is not necessary; a curved transition may also be provided, e.g. beads which are arcuate in cross-section are also possible.

The two through-openings 11b or the lines 100 through the plate stack of the system 1 that are formed by the through-openings 11b are in each case in fluid connection with each other via the passages 13b crossing the sealing beads 12b, via the distributing structures of the distribution or collection region 20 and via the flow field 17 in the active region 18 of the first individual layers 2a facing towards the viewer of FIG. 2. Analogously, the two through-openings 11c or the lines 100 through the plate stack 6 of the system 1 that are formed by the through-openings 11c are in each case in fluid connection with each other via corresponding conveying channels, via corresponding distributing structures and via a corresponding flow field on an outer side of the second individual layers 2b facing away from the viewer of FIG. 2. To this end, respective channel structures for guiding the relevant media are provided in the active regions 18.

In contrast, the through-openings 11a or the lines 100 through the plate stack of the system 1 that are formed by the through-openings 11a are in each case in fluid connection with each other via a cavity 19 which is surrounded or enclosed by the individual layers 2a, 2b. This cavity 19 serves in each case to guide a coolant through the bipolar plate 2, such as for cooling the electrochemically active region 18 of the separator plate 2. The coolant thus serves primarily to cool the electrochemically active region 18 of the separator plate 2. The coolant flows through the cavity 19 from an inlet opening 11a towards an outlet opening 11a. Mixtures of water and antifreeze are often used as coolants. However, other coolants are also conceivable. For guidance of the coolant or cooling medium, channel structures are present on the inner side of the separator plate 2. These are not visible in FIG. 2 since they extend, for example, on the surface of the individual layer 2a facing away from the viewer; they are therefore situated opposite the above-mentioned channel structures on the other surface of the individual layer 2a. In the active region 18, the channel structures guide the cooling medium along the inner side of the separator plate towards the outlet opening 11a.

FIG. 3 shows a section through the system 1 according to the prior art in the region of one of the through-openings 11a-c. For the sake of simplicity, reference will be made below to a through-opening 11, which can represent one of the through-openings 11a-c. Similarly, reference will be made to a sealing bead 12, which can be one of the sealing beads 12a-12c in an individual layer. Here it is possible to see the end plate 4 and a separator plate 23 comprising individual layers 2a, 2b. Separator plates 23 adjacent to the end plates 3, 4 are often called terminating separator plates, stack terminating plates or unipolar plates/monopolar plates. In the embodiment of FIG. 3, the terminating separator plate 23 is only partially identical to the other separator plates 2 of the system 1. While the other separator plates 2 of the system 1 have passages such that media can be supplied both to the two outer surfaces and to the interior 19, in the case of the terminating separator plate 23 the intermediate space between the separator plate 23 and the end plate 4 is not supplied with gas; here, no passage 13 is formed in the layer 2b at any of the through-openings 11. It is therefore not possible to form the layer 2b as a part identical to the other corresponding layers 2b of the stack.

The separator plates 2 of the fuel cell stack 6, such as in the case of the terminating separator plate 23, are usually embossed metal parts made of stainless steel with a linear thermal expansion coefficient of 1.6 ∜10-5 K-1. In contrast, the end plates 3, 4 are at least predominantly or mainly made of a plastic which has, for example, a linear thermal expansion coefficient of around 5.0·10-5 K-1, wherein the differences with regard to the linear expansion coefficients are significantly greater between different plastics than between different steel materials. The terminating separator plate 23 therefore has a lower linear thermal expansion coefficient than each of the end plates 3 or 4 to which it is adjacent. This means, for example, that the end plate 4 and the terminating separator plate 23 adjacent thereto do not change their lateral expansion in the xy plane perpendicular to the stacking axis 7 to the same extent when the temperature of the end plate 4 and of the terminating separator plate 23 increases or decreases by the same amount. Due to the different thermal expansion of the terminating separator plate 23 and of the end plate 4, regions of the two plates 4 and 23 are displaced relative to each other. This is not an absolute displacement, but rather, in simplified terms, an increasing lateral displacement between the regions of the two plates 4 and 23 relative to each other occurs as the distance of the plate regions from the center of gravity of the terminating bipolar plate 23 increases. Furthermore, the displacement is influenced by different temperature distributions and changes in temperature, for example depending on the material thickness. Such changes in temperature may be caused by a change in the ambient temperature, by a cold start of the fuel cell system when the ambient temperature is low, or by an increase or decrease in the temperature inside the fuel cell stack 6, for example as a result of waste heat being generated when converting chemical energy into electrical energy. These relative movements may adversely affect an elastomeric sealing device or coating 28 arranged between one of the bead arrangements 12a-12d of the terminating separator plate 23 and the first end plate 4. Furthermore, it has been found in practice that the end plates 4, which are made of a plastic material, react more slowly to changes in temperature than the separator plates 2, 23, which are made of a steel material, and this amplifies the differences or relative displacements at least temporarily. In addition, at least some sections of the metal separator plates are cooled directly, while often no active cooling or temperature control is provided for the end plates.

The present disclosure was conceived in order to solve or at least mitigate the problems mentioned above. For example, the aim is to improve the leaktightness of the system. Furthermore, the aim is to use as many identical parts as possible so that the system can be simplified and a saving can be made in terms of costs and tools.

An assembly 30 for an electrochemical system 1 is proposed, such as the electrochemical system 1 described above. The assembly 30 comprises a first separator plate 32, which is designed as a single layer and as a stack terminating plate, and a support element 40. The present disclosure will be further explained below with reference to FIGS. 4-11. Each of FIGS. 4, 5, 6A and 7-9 shows the compressed state of the respective plates.

The first separator plate 32 can be formed by one of the layers 2a, 2b described above and thus does not have to be specially designed for the present disclosure.

In a manner analogous to the bead arrangements 12a-12c described above, the first separator plate 32 has a first sealing bead 12 for sealing off an area of the first separator plate 32. Here, the first sealing bead 12 projects out of a plate plane E32 defined by the first separator plate 32 and has a bead interior 35, which is open on a rear side 24 of the first separator plate 32, and a bead top 36, which is cantilevered on a front side 25 of the first separator plate 32.

The first separator plate 32 comprises at least one through-opening 11 for the passage of a fluid, wherein the first sealing bead 12 is arranged circumferentially around the through-opening 11 and seals off the latter. The through-opening 11 may be designed in the same way as one of the through-openings 11a-c described above. A plate body of the first separator plate 32 is usually made of a metal material, such as stainless steel or a titanium alloy. The first separator plate 32 may be designed as a sheet-metal layer which has a thickness of at least 70 μm and/or at most 100 μm.

The support element 40 projects into the bead interior 35 in order to support the bead top 36. The support element 40 often extends along the entire course of the first sealing bead 12. Since the sealing bead 12 usually in turn extends around the through-opening 11 in order to seal off the through-opening 11, the support element 40 is also arranged around the through-opening 11 and extends around the through-opening 11.

Hereinbelow, a height direction is defined perpendicular to the plate plane. A maximum height of the support element 40 is often smaller than a height of the first sealing bead 12 measured from the plate plane to the neutral axis of the metal sheet in the region of the bead top 36 in the non-compressed state of the assembly 30. In the compressed state of the assembly 30, the first sealing bead 12 is compressed to the operating point and comes into contact with the support element 40. The support element thus acts as a mechanical stop for the sealing bead 12. The height of the support element 40 may be at least 60%, at least 70%, at least 75%, or at least 80% of the bead height in the non-compressed state of the assembly 30.

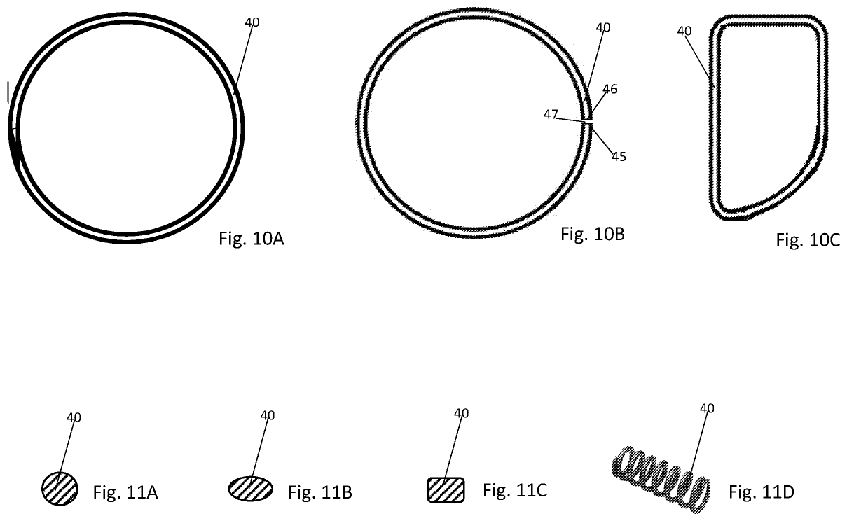

The support element 40 may for example be made of a metal material. FIGS. 10A-10C show plan views of different support elements 40. The support elements 40 of FIGS. 10A and 10B are ring-shaped, with the support element 40 of FIG. 10A comprising a closed ring element and the support element of FIG. 10B comprising an interrupted ring element having two end portions 45, 46. In this case, the support element 40 may be designed as a wire. The end portions 45, 46 may butt against each other and/or be oriented facing each other in the installed state. The interruption 47 extending between the end portions 45, 46 may facilitate installation of the ring-shaped support element 40. As an alternative or in addition, the interruption 47 may be designed as a fluid passage or may contribute thereto. The support element 40 of FIG. 10C likewise has a closed course, but with rounded corners, straight portions and one curved portion. Other shapes for the support element 40 are also conceivable and usually depend on the shape of the through-opening 11 or the course of the sealing bead 12.

FIGS. 11A-11C show different cross-sections through the support element 40. The cross-sections shown in FIGS. 11A-11C are made transversely to the course of the support element 40. By way of example, the cross-section of the support element 40 may be round (FIG. 11A), oval (FIG. 11B) or rounded-rectangular (FIG. 11C). The support element 40 generally has a cross-section that is constant along its course. FIG. 11D additionally shows, in a cut-away oblique view, a support element 40 comprising a wire ring coiled into a spiral. Alternatively, a metal sheet could be rolled up and shaped into a ring.

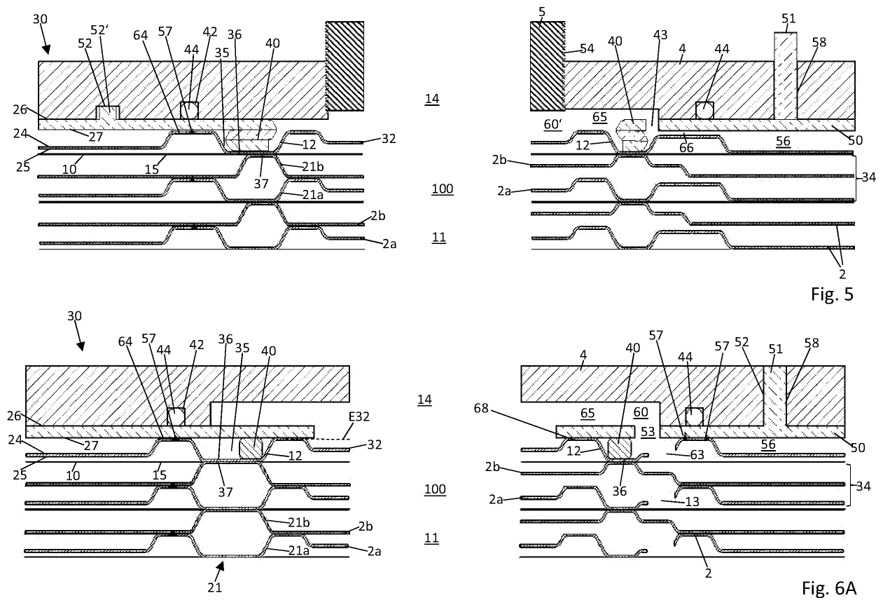

The assembly 30 may further comprise a first end plate 4, for example the aforementioned first end plate 4. The end plate 4 usually has a plate body which is at least predominantly or mainly made of a plastic material. As already mentioned above, the first end plate 4 has a plurality of media ports 5, the media ports 5 of the first end plate 4 being fluidically connected to the through-openings 11 of the first separator plate 32. The media ports 5 may be formed integrally with the end plate 4 and project therefrom, as shown in FIGS. 4 and 8, or may be designed as connectors 59 (see FIG. 5) which are pushed or screwed into the end plate 4. Connectors that have been pushed in are not shown here. The first sealing bead 12 of the first separator plate 32 often points away from the first end plate 4. Furthermore, the support element 40 is usually arranged between the first separator plate 32 and the first end plate 4.

A contacting plate 50 may be arranged between the end plate 4 and the first separator plate 32, the front side 27 of said contacting plate usually being adjacent to the rear side 24 of the first separator plate 32. The rear side 26 of the contacting plate is adjacent to the end plate 4. The first separator plate 32 and the contacting plate 50 may be connected to each other electrically and/or in a media-tight manner. The contacting plate 50 is made of an electrically conductive material and may have a thickness of at least 0.5 mm, at least 1.0 mm, at least 2.0 mm and/or at most 10 mm, at most 8 mm, or at most 5 mm. Overall, the thickness of the contacting plate 50 may be at least forty times, at least fifty times greater than a thickness of the first separator plate 32.

An electrical voltage generated by the electrochemical cells of the system 1 relative to the zero potential can be tapped at the contacting plate 50. An electrical connection between the contacting plate 50 and an outer side of the system 1 can be established via a metal electrical conductor 51. The conductor 51 and the contacting plate 50 are in electrical contact with each other at a rear side 26 of the contacting plate 50 facing towards the end plate 4. In the embodiment of the system 1 shown here, the contacting plate 50 and the metal electrical conductor 51 are formed in one piece, for example as a one-piece cast part. The conductor 51 extends from the rear side 26 of the contacting plate 50 to the outer side of the system 1, such as to an outer side of the end plate 4 facing away from the stack terminating plate 32. The conductor 51 engages in a through-opening 58 in the end plate 4. The through-opening 58 extends from the outer side of the end plate 4 to an inner side of the end plate 4 facing towards the contacting plate 51. The contacting plate is formed from a metal such as copper or stainless steel. The conductor 51 forms a protrusion in the form of a bolt on the rear side 26 of the contacting plate 50. The end of the conductor 51 facing away from the contacting plate 50 is usually in electrical contact with an electrical cable, which is connected for example to an electrical load.

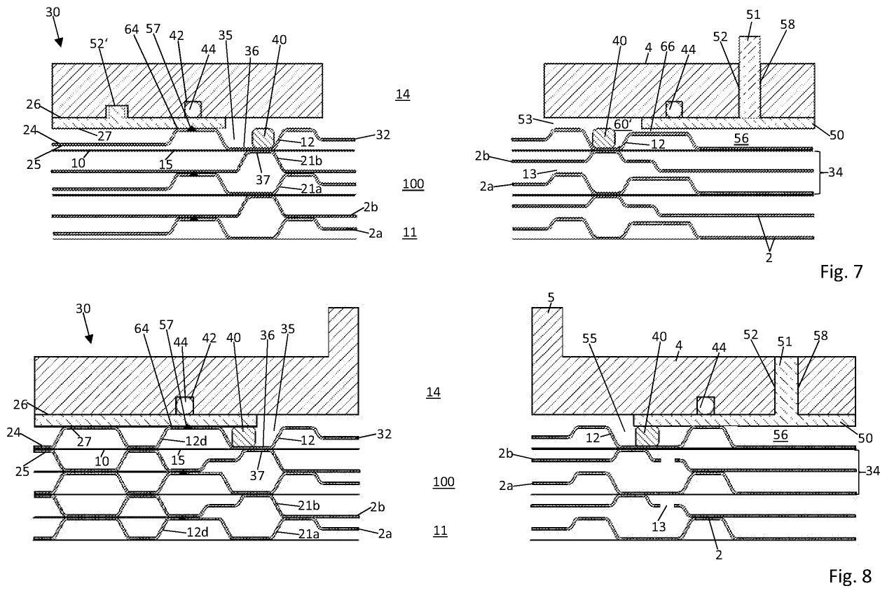

In FIGS. 5 and 7, the conductor 51 and the contacting plate 50 are welded to each other. The conductor 51 may for example be formed in one piece, for example as a one-piece shaped part in the manner of a bolt, see also FIGS. 5 and 7.

The contacting plate 50 may have a fastening possibility 52 for fastening the contacting plate 50 to an end plate 4, for example in the form of the conductor 51 and/or in the form of an additional element 52′ (cf. FIGS. 5 and 7).

The first separator plate 32 and the contacting plate 50 may be connected to each other in a materially bonded manner, for instance by at least one welded joint 57. The welded joint 57 may be designed as a sealing weld line extending around the through-opening 11 and may be designed to seal off an intermediate space 56 arranged between the first separator plate 32 and the contacting plate 50. The intermediate space 56 extends between the rear side 24 of the first separator plate 32 and the front side 27 of the contacting plate 50 and is designed as a cavity for receiving a fluid.

Via a channel fluidically connected to the through-opening 11 (cf. through-opening 11a in FIG. 2) or via a fluid passage formed in the first sealing bead 12 and/or the support element 40, the intermediate space 56 is often supplied with coolant in order to cool the rear side 24 of the first separator plate 32. In the section shown in FIG. 4, the fluid passage is composed of a cutout 63 in the flank of the bead 12 facing towards the through-opening 11, a cutout 43 in the support element 40 and an elevation 66 of the right-hand bead foot of the bead 12. In the section shown in FIG. 5, the fluid passage of the coolant takes place from the through-opening 11 to the intermediate space 56 via a cutout 65 in the end plate 50, a cutout 43 in the support element 40 and again an elevation 66 of the right-hand bead foot of the bead 12. In contrast, the embodiment of FIG. 7 enables the comparable passage of coolant only via a cutout 53 in the contact plate 50 and an elevation 66 of the right-hand bead foot of the bead 12. All these fluid lines form a coolant channel 60′.

The support element 40 bridges the gap between the bead interior and the first end plate 4 and is thus designed as a dimensionally stable, rigid spacer. On a side facing away from the first separator plate 32, the support element 40 may be adjacent to the first end plate 4. The support element 40 may be fastened to the end plate 4, for example by being pressed in, screwed thereto or fastened by means of an adhesive. In the embodiment of FIG. 4, a cutout 55 designed to receive the support element 40 is formed in the end plate 4.

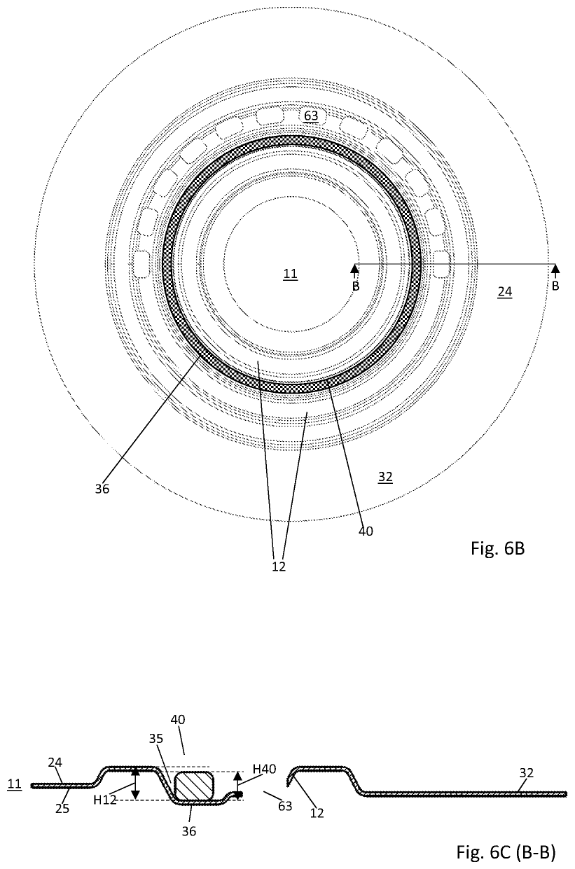

Alternatively, the support element 40 may be adjacent to the contacting plate 50 on a side facing towards the first separator plate 32. In this case, the support element 40 may be fastened to the contacting plate 50, cf. FIGS. 6A and 7-9, for example by means of an adhesive. In the embodiments of FIGS. 6A and 7-9, the support element 40 and the contacting plate 50 are designed as two individual parts, with the support element 40 being arranged between the contacting plate 50 and the first separator plate 32. In FIG. 5, on the other hand, the support element 40 and the contacting plate 50 are formed in one piece. In this case, the support element may be formed by a protrusion formed on the front side 27 of the contacting plate 50, or may be formed by a folding of the plate material of the contacting plate 50 as shown in FIG. 5. The fold need not be a double fold as shown; even single folds may suffice given a suitable material thickness.

The material used for the support element 40 may differ from the material of the contacting plate 50 and/or the material of the first separator plate 32 and/or the material of the end plate 4. Alternatively, the same material may be used for the support element 40 and the separator plate 32 and/or the contacting plate 50. In principle, however, it is also possible to manufacture the support element 40 from the same material as the end plate 4, e.g. also from a plastic material, provided that this has an acceptably low tendency to subside. Plastics that contain a high proportion of reinforcing substances, for example fibres, may be suitable for this.

Therefore, in the region of the first sealing bead 12, such as the bead top 36 thereof, the first separator plate 32 is supported, by means of the support element 40, on the first end plate 4, cf. FIGS. 4 and 5, or on a plate placed between the end plate 4 and the separator plate 32, cf. for example the contacting plate 50 in FIGS. 6A, 8 and 9. Support is provided even when there is no contact in some parts around the circumference of the through-opening 11 because a fluid is being routed through the intermediate space.

The first end plate 4 may have a cutout or depression 42 for receiving a sealing element 44. The sealing element 44 is arranged between the contacting plate 50 and the first end plate 4 and seals off the area between the plates 4, 50 with respect to fluid from the through-opening 11. The sealing element 44 may be designed, for example, as an elastomeric O-ring, wherein the latter may be sunk into a receptacle in the compressed state so that it lies in the force shunt. The sealing can thus be achieved independently of the sealing line of the sealing bead 12.

The first separator plate 32 may additionally have a contact area 64, wherein the contact area 64 between the left-hand bead flank of the bead 12 to the left of the through-opening 11 and the right-hand bead flank of the perimeter bead 12d extends in the plate plane defined by the first separator plate 32 and bears against the front side 27 of the contacting plate, cf. FIGS. 4-7. The contact area 64 results from the integral forming of the bead 12 that extends around the through-opening 11, and possibly also of the perimeter bead 12d, these usually being integrally formed in the plate body of the first separator plate 32 by embossing, hydroforming or deep-drawing. In the region of the contact area 64, for example, the first separator plate 32 may be connected to the contacting plate 50 in a materially bonded manner, cf. the aforementioned welded joint 57. The sealing element 44 and the contact area 64 are often located on opposite sides of the contacting plate 50, wherein projections of the sealing element 44 and of the contact area 64 perpendicular to a plate plane of the contacting plate 50 overlap. The sealing element 44 therefore ensures sealing between the first end plate 4 and the contacting plate 50, while the materially bonded connection 57 performs the sealing between the contacting plate 50 and the first separator plate 32. Perimeter beads 12d are shown here only in the embodiments of FIGS. 4 and 8, but could also be implemented in the other embodiments.

The first separator plate 32 may additionally have a further bearing area 68, which is adjacent to the end plate 4—cf. FIG. 4—or to the contacting plate 50—cf. FIG. 6A—and extends on the other side of the bead 12 facing towards the through-opening 11. This bearing area 68 once again extends in the plate plane E32 defined by the first separator plate 32 and results from the integral forming of the bead 12 in the plate body of the first separator plate 32 by means of embossing, hydroforming or deep-drawing. However, the bearing area 68 need not extend as far as the through-opening 11, cf. FIGS. 4 and 6A.

At least one channel 60, 60′ for the passage of the fluid routed through the through-opening 11 may be provided in order to individually supply the front side 25 or the rear side 24 of the first separator plate 32 with fluid, such as a reaction medium (in this case the channel is referred to as channel 60) or a coolant (in this case, as already mentioned above, the channel is referred to as channel 60′). The channel 60, 60′ is therefore fluidically connected to the through-opening 11, the media opening 14 and/or a fluid line 100 formed by the through-openings 11, cf. FIGS. 5-9.

The channel may extend in part between the first separator plate 32 and the first end plate 4 (cf. FIGS. 4-7 and 9) and/or between the first separator plate 32 and the contacting plate 50 (cf. FIGS. 4-7 and 9). In contrast, in the embodiment of FIG. 8, no such channel is formed adjacent to the through-opening 11 that conducts the medium that is fed between the MEA 10 closest to the end plate 4 and the separator plate 2b closest to the end plate 4, but instead only bead passages 13 are formed in the other separator plates 2b of the stack.

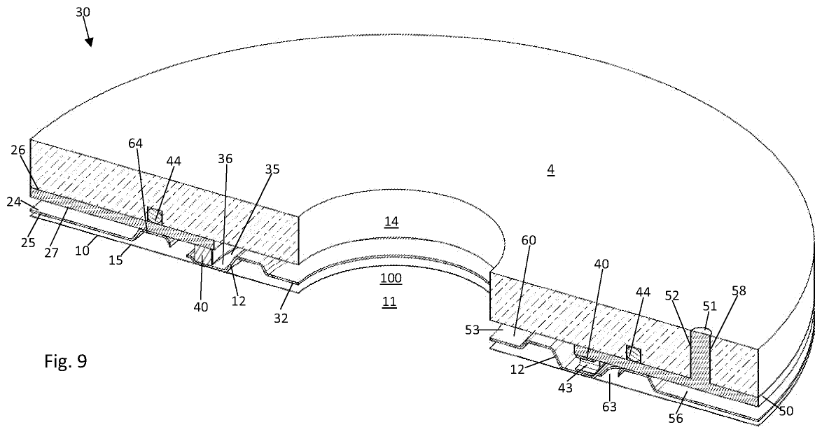

The channel 60 may be formed at least in part in the end plate 4, for example by at least one fluid passage 65, such as an opening, cutout or depression, which is formed in the end plate 4, cf. FIG. 6A. In addition or as an alternative, the channel may extend at least in part as a fluid passage 53 in the contacting plate 50 and may be formed there as a depression, opening or cutout, cf. FIGS. 6A and 9. In addition or as an alternative, the channel 60 may also extend in part in the support element 40, where it may be designed, for example, in the form of a fluid passage 43, such as a through-hole, cf. FIG. 9. Depending on whether the channel 60 functions as a fluid supply line or fluid discharge line, the channel 60 may have an inlet or outlet opening 63 formed in the first separator plate 32. The opening, which is designed as a fluid passage 63, may be arranged between the bearing area 66 and the bead top 36 of the sealing bead 12.

FIG. 6B shows, in a plan view of the separator plate 32, the course of the support element 40 on the rear side 24 of the separator plate, e.g. the surface facing towards the end plate 4, around the through-opening 11. Here, the support element is accommodated in the interior 35 of the bead 12. The section B-B in this figure is shown on an enlarged scale in FIG. 6C. It is clear from this view of the non-compressed state that, in the non-compressed state, the support element 40 has a height H40 which is smaller than the height H12 of the bead.

The assembly 30 may further comprise a second separator plate 34, which is designed as a double layer and comprises a first layer 2a and a second layer 2b which are connected to each other. Here, the second separator plate 34 is arranged on the front side 25 of the first separator plate 32. The above-described membrane electrode assembly (MEA) 10 may be arranged between the first separator plate 32 and the second separator plate 34. It can be seen in the figures that the frame-like reinforcing layer 15 extends across the entire surface area between the separator plates 32, 34.

The second separator plate 34 may have a bead arrangement 21, which may be designed in the same way as the bead arrangements 12a-c described above. The bead arrangement 21 of the separator plate 34 is formed by two sealing beads 21a, 21b of the respective individual layers 2a, 2b and seals off an area of the separator plate 34 with respect to the through-opening 11.

The first sealing bead 12 of the first separator plate 32 and the sealing bead 21b of the second layer 2b face towards each other with their bead tops 36, 37; these bead tops 36, 37 extend parallel to each other. With the exception of the embodiment of FIG. 6, all the separator plates 34 here may be designed in such a way that the sealing beads 21a, 21b are asymmetrical to each other, either due to the fact that the bead tops 36, 37 thereof have a different width or due to the fact that at least one of the bead flanks thereof has a stepped gradient.

For example, The second separator plate 34 is an identical design to the first separator plate 32, which is designed as a single layer and as a stack terminating plate.

The first sealing bead 12 and/or the sealing beads 21a, 21b are typically integrally formed in the respective separator plate, more precisely in the plate body of the respective separator plate, for example by embossing, hydroforming and/or deep-drawing. It may be provided that the separator plates 32, 34, the sealing beads 12, 21a, 21b, have a coating, for instance in the region of their bead tops. The coating is applied to the plate body of the respective separator plate 32, 34 and may be designed, for example, as a polymer coating, in which case it differs from the plate body of the separator plates 32, 34 in terms of the material. The coating of the first sealing bead 12, as well as that of the sealing beads 21a, 21b, may act as a microseal.

The assembly 30 may comprise a plurality of further separator plates 2. For details regarding the separator plates 2, reference is made to the above description in connection with FIGS. 1-3. It should be noted that the second separator plate 34 and the further separator plates 2 may be of identical design.

The assembly 30 may additionally also comprise the second end plate 3, but the latter may not have any media ports. The separator plates 2, 32, 34, the MEAs 10 and the contacting plate 50 are arranged between the end plates 3, 4 and are compressed therebetween. Overall, therefore, the assembly 30 may form the above-described stack 6 or the electrochemical system 1 or may be a component of the system 1 or of the stack 6.

FIGS. 1-11D are shown approximately to scale. FIGS. 1-11D show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An assembly for an electrochemical system, comprising:
a first separator plate which is a single layered stack terminating plate, and
a support element,
wherein the first separator plate has a first sealing bead for sealing off an area of the first separator plate, wherein the first sealing bead projects out of a plate plane defined by the first separator plate and has a bead interior, which is open on a rear side of the first separator plate, and a bead top, which is cantilevered on a front side of the first separator plate,
wherein the support element projects into the bead interior in order to support the bead top.

2. The assembly according to claim 1, wherein the support element is a rigid spacer.

3. The assembly according to claim 1, wherein the first separator plate has at least one through-opening for the passage of a fluid, wherein the first sealing bead is arranged around the through-opening and seals off the through-opening.

4. The assembly according to claim 1, wherein the support element and/or the first sealing bead has at least one fluid passage for the passage of a fluid.

5. The assembly according to claim 1, wherein the support element extends along the entire course of the first sealing bead.

6. The assembly according to claim 1, wherein the support element has a round, oval, or rounded-rectangular cross-section.

7. The assembly according to claim 1, wherein a height direction is defined perpendicular to the plate plane, wherein a maximum height of the support element is smaller than a height of the first sealing bead measured from the plate plane to the neutral axis of the bead top in the non-compressed state of the assembly.

8. The assembly according to claim 1, wherein a plate body of the first separator plate and/or the support element are made of a metal material.

9. The assembly according to claim 1, comprising a contacting plate adjacent to the rear side of the first separator plate, wherein the first separator plate and the contacting plate are connected to each other electrically and/or in a media-tight manner.

10. The assembly according to claim 9, wherein the support element and the contacting plate
are formed in one piece, or
are formed as two individual parts, wherein the support element is arranged between the contacting plate and the first separator plate.

11. The assembly according to claim 9, wherein the contacting plate has a fastening possibility for fastening the contacting plate to an end plate.

12. The assembly according to claim 9, wherein the first sealing bead and/or the support element in each case have at least one fluid passage which routes a fluid into an intermediate space arranged between the first separator plate and the contacting plate.

13. The assembly according to claim 9, wherein the first separator plate and the contacting plate are welded to each other in order to seal off an area arranged between the first separator plate and the contacting plate.

14. The assembly according to claim 1, further comprising a first end plate, wherein the first sealing bead of the first separator plate points with its bead top away from the first end plate and the support element is arranged between the first separator plate and the first end plate.

15. The assembly according to claim 14, wherein a contacting plate is adjacent to the first end plate and is arranged between the first end plate and the first separator plate.

16. The assembly according to claim 1, further comprising a second separator plate comprising a first layer and a second layer which are connected to each other,
wherein the second separator plate is identical to the first separator plate, and the second separator plate is arranged on the front side of the first separator plate.

17. The assembly according to claim 16, wherein the second layer of the second separator plate has a second sealing bead for sealing off an area of the second separator plate, wherein the first sealing bead of the first separator plate and the second sealing bead of the second layer face each other with their bead tops and extend with their bead tops parallel to each other.

18. An electrochemical system, comprising the assembly according to claim 1, the electrochemical system comprising a plurality of further separator plates, and a second end plate, wherein the first end plate has a plurality of media ports, wherein the media ports of the first end plate are fluidically connected to through-openings of the first separator plate, wherein the first separator plate and the further separator plates are arranged and compressed between the two end plates, as a result of which a stack is formed.

19. The electrochemical system according to claim 18, comprising a further assembly which is arranged between the plurality of further separator plates and the second end plate.

20. The electrochemical system according to claim 19, wherein the second end plate does not have a through-opening for the passage of a fluid.
